(19) United States
(12) Patent Application Publication
(10) Pub. No.: US 2004/0244202 A1
(43) Pub. Date: Dec. 9, 2004

(54) Needle cutting device

(76) Inventors: Paul Alun Miles Bull, Lincolnshire (GB); Allan Cowell, Woodbridge (GB); Barrie Hart, Ipswich (GB)

Correspondence Address: William W Enders, O'Keefe Egan & Peterman, Building C Suite 200, 1101 Capital of Texas Highway South, Austin, TX, 78746, US

(21) Appl. No.: 10/481,175

(22) PCT Filed: Jun. 20, 2002
(86) PCT No.: PCT/GB02/02820

(30) Foreign Application Priority Data
Jun. 21, 2001 (GB) 0115191.9

(51) Int. Cl. B26B 3/00

(52) U.S. Cl. 30/124

(57) ABSTRACT

A needle cutting device (1) for cutting a needle (6) from a mount in a syringe (8) comprises cutting apparatus (220) and a container for storing cut needles. The container includes an aperture (4) having an axis along which a needle, but not a mount associated with the needle, may be introduced into the container. The cutting apparatus has first and second cutting surfaces (222, 223), at least the first cutting surface (222) being located at an end of a flexible blade member (226). The first cutting surface (222) is movable relative to the second cutting surface (223) in a direction transverse to the axis of the aperture by movement of at least part of the blade member in a direction substantially parallel to the axis of the aperture to move the first cutting surface relative to the second cutting surface in order to nip and cut a needle within the aperture.

### FIELD OF THE INVENTION

The present invention relates to a needle cutting device for cutting the needle from a mount in a syringe.

### BACKGROUND TO THE INVENTION

Needle stick injuries resulting from accidental contact with a syringe needle pose a serious health risk, particularly if the syringe has been in contact with blood.

Removing the needle from the mount of a syringe and safely storing the cut needles reduces the risk of such injuries. Current devices for cutting the needle from the syringe leave a small portion of the needle projecting from the mount. Although this reduces the risk of needle stick injuries, the possibility of such an accidental injury still exists.

A device that subjects a syringe needle to a high voltage, thereby melting the needle and syringe mount, does remove the entire needle, but is not suitable for use by a non-professional user.

It is an object of the present invention to provide an improved needle cutting device.

### SUMMARY OF THE INVENTION

According to an aspect of the invention there is provided a needle cutting device for cutting a needle from a mount in a syringe, the device comprising a container for storing cut needles, the container including an aperture having an axis along which a needle, but not a mount associated with said needle, may be introduced into the container, the device including cutting apparatus comprising first and second cutting surfaces, at least the first cutting surface being located at an end of a flexible blade member, the first cutting surface being movable relative to the second cutting surface in a direction transverse to the axis of the aperture by a force applied to at least part of the flexible blade member in a direction substantially parallel to the axis of the aperture in order to nip and cut a needle within the aperture.

Another aspect of the invention provides a needle cutting device for cutting a needle from a mount in a syringe, the device comprising a container for storing cut needles, the container including an aperture having an axis along which a needle, but not a mount associated with said needle, may be introduced into the container, the device including cutting apparatus comprising first and second cutting surfaces, at least the first cutting surface being located at an end of a flexible blade member, the first cutting surface being movable relative to the second cutting surface in a direction transverse to the axis of the aperture to nip and cut a needle within the aperture at or adjacent the mount such that substantially no portion of the remaining needle protrudes from the mount.

The term “blade member” is used herein to refer to a support member for a cutting surface. This support may be integral with the cutting surface or formed from more than one part. In a preferred embodiment the blade member and cutting surface are integral.

The nip and cut action is not a shearing action as would be found in a pair of scissors, but is a crushing action similar to that found in a wire cutter. This action removes the need for one cutting surface to slide over the other. If one cutting surface is to slide over the other there must be room between the mount and the cutting location for one cutting surface to move between the mount and the second cutting surface and this will leave a small portion of the needle protruding from the mount. By using devices with a nip and cut cutting action substantially all of the needle that protrudes from the mount can be removed. The cut needle is then retained within the container and hence the risk of a needle stick injury is reduced.

It should be understood that the force required to cause the first cutting surface to move relative to the second cutting surface may be applied to the flexible blade member at any angle provided that at least a component of the force is substantially parallel to the axis of the aperture. Any force that includes a component substantially parallel to the axis of the aperture may cause relative movement of the cutting surfaces. The applied force causes at least part of the blade member to move, preferably by flexing, and to have a component of that movement in a direction substantially parallel to the direction of the axis of the aperture.

The walls of the container should be made from a material through which a cut needle may not pierce. If a needle can pierce the wall of the container the risk of an accidental needle stick would be increased. Preferably the container is made of a plastics material.

Once the needle, or cannula, has been removed from a syringe the risk of injury from the syringe is greatly reduced and the syringe can be disposed of in a normal way without the need for sharps precautions.

The container can preferably hold 2000, and preferably up to 3000, cut needles. These values exceed the US requirement of 1500 and the EU requirement of 700. Once the container is full, it can either be emptied and reused or disposed of while full. Disposing of the container while full is preferable to avoid the risk of a needle stick injury occurring while emptying the container.

The entire device may be disposed of when the container becomes full. This is preferable because Cutting surfaces generally have a limited lifetime and may become contaminated with blood during use. The disposal of the entire device will remove the need to replace the cutting surfaces over time and reduce the risk of exposure to contaminated cutting surfaces.

In a preferred embodiment the device includes biasing means to resiliently bias the cutting surfaces to a predetermined position. This effectively resets the device for its next use and makes operation of the device easier for the end user.

The predetermined position of the cutting surfaces may be such that the aperture is substantially covered so that no cut needle may fall out of the container, even when the device is shaken. This makes the device safer for transport and reduces the possibility of an accidental needle stick injury as a needle falls from the device.

The device may include a non-return valve within the aperture to allow needles to be forced into the container, but not exit through the aperture.

An alternative means for preventing the needles from falling back out of the container is to provide a strong magnet within the container. Since most needles are ferromagnetic, the magnet helps retain the needles in the container.

Preferably the resilient biasing means is a leaf spring and the flexible blade member may comprise the leaf spring. This reduces the manufacturing complexity of the device and hence reduces the cost. The blade member and the first and second cutting surfaces are preferably part of a unitary structure as this reduces the number of parts in the device and also reduces the need to accurately position many parts with respect to one another when assembling the device.

The force applied to at least part of the blade member in a direction substantially parallel to the axis of the aperture may be caused by contact with the mount during the insertion of a needle through the aperture. Preferably the needle is to be cut adjacent to the mount and if movement of the mount is causing the cutting action to occur, it can be ensured that the cutting surfaces nip and cut the needle at the correct location with respect to the mount. Preferably, as the needle is inserted through the aperture, the mount makes contact with the blade member and as the mount is moved closer to the aperture, the mount urges the cutting surfaces together so as to nip and cut the needle.

Preferably the external entrance to the aperture is a funnel shape so as to help guide the syringe and needle into the correct orientation with respect to the cutting surfaces. Having a wide external opening also makes the initial insertion of the needle into the device easier and hence safer as it is less likely that the user will miss the aperture and risk a needle stick injury.

A further aspect of the invention provides a needle cutting device for removing a needle from a mount in a syringe, the device comprising a container for storing cut needles, the container including an aperture through which a needle, may be introduced into the container, the device including cutting apparatus;

the arrangement being such that movement of the syringe to a predetermined location in which the needle is disposed through the aperture causes or permits the cutting apparatus to cut the needle from its mount so as to leave substantially no portion of the needle projecting from the mount.

By permitting or causing cutting of the needle only when the syringe is in a predetermined position it can be ensured that the needle is cut at the correct location with respect to the mount.

The cutting apparatus may be actuated, or cutting permitted, by an electronic sensing means within the device that senses the position of part of the syringe and either causes or allows the cutting apparatus to cut the needle when it is sensed that the syringe is correctly positioned.

It may be a mechanical device that permits or causes the cutting of the needle when the syringe reaches a predetermined location. In a preferred embodiment, it is the mount of the syringe making contact with the cutting surfaces and the user forcing the syringe into the device that causes the cutting surfaces to cut the needle. This is preferred because it is one action, the insertion of the needle into the container, that causes cutting of the needle and since the cutting surfaces are making contact with the mount, the needle will be cut at the correct location.

### BRIEF DESCRIPTION OF THE DRAWINGS

The invention will now be further described, by way of example, with reference to the accompanying drawings, in which:

FIG. 1 shows a needle cutting device according to the invention and a syringe;

FIG. 2 shows a different embodiment of the cutting device of FIG. 1;

FIG. 3 shows an embodiment of cutting apparatus suitable for use with the device of FIG. 2, including cutting surfaces and a blade member formed integrally;

FIG. 4 shows a second embodiment of cutting apparatus of FIG. 3;

FIG. 5 shows an embodiment of cutting apparatus suitable for use with the device of FIG. 1, including cutting surfaces and two blade members all formed integrally;

FIG. 6 shows a different embodiment of the cutting apparatus of FIG. 5;

FIGS. 7 and 8 show non-return valves suitable for use in the invention;

FIGS. 9 and 10 show exploded diagrams of the cutting devices of FIGS. 1 and 2 showing the relative position of the parts;

FIG. 11 shows a cross section of the cutting device of FIG. 2 with a needle inserted through the aperture; and

FIG. 12 shows a cross section of the cutting device of FIG. 1 with a needle inserted through the aperture.

### DETAILED DESCRIPTION

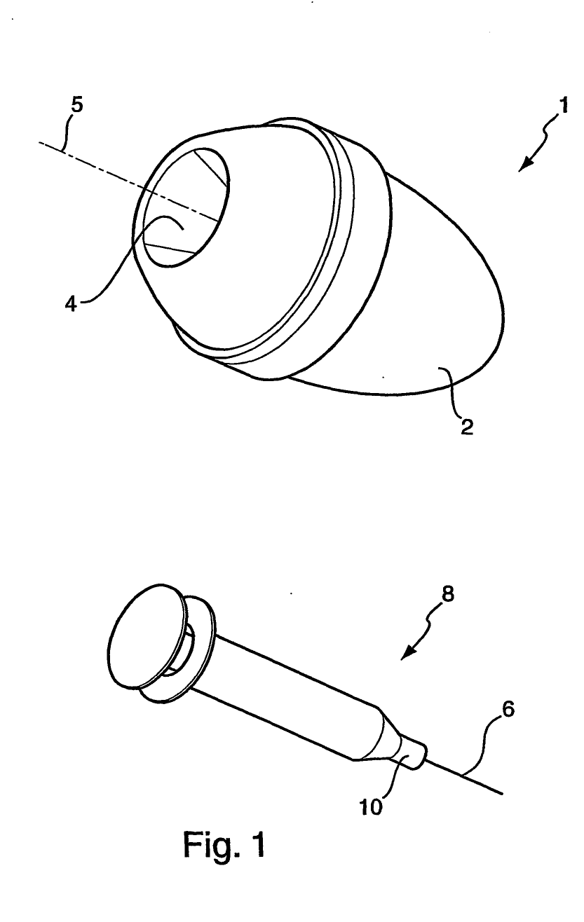

FIG. 1 shows a needle cutting device 1 having a container 2 for cut needles (not shown). The container has an aperture 4 in the centre of one end. The aperture 4 has an axis 5 along which a needle 6 from a syringe 8 may be moved to enter the container 2. The aperture 4 is tapered such that the mount 10 of the syringe 8 in which the needle 6 is mounted is guided into the correct orientation with respect to the cutting apparatus (best shown in subsequent figures) within the device 1. This ensures that the needle 6 is cut from the mount 10 as close to the mount 10 as possible.

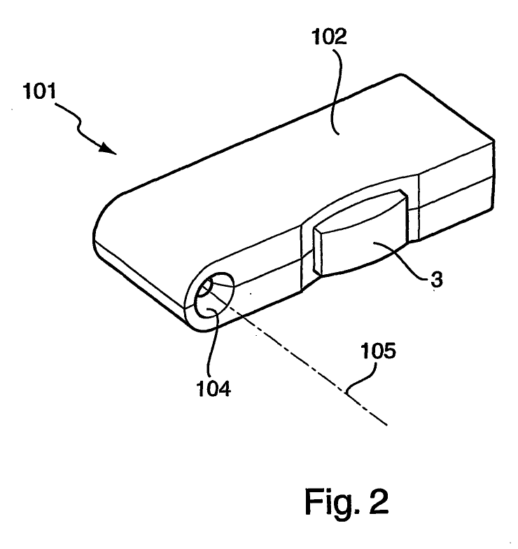

FIG. 2 shows a different embodiment of the cutting device of FIG. 1. Features that are the same as in FIG. 1 will be given similar reference numerals, incremented by 100.

The cutting device 101 has a container 102 for storing cut needles (not shown). The device has an aperture 104 with an axis 105 along which a needle 6 may be introduced into the container 102. The aperture 104 is located off-centre in one side. The device 101 includes a button 3 which is pressed into the device 101 to nip and cut a needle 6 within the aperture 104.

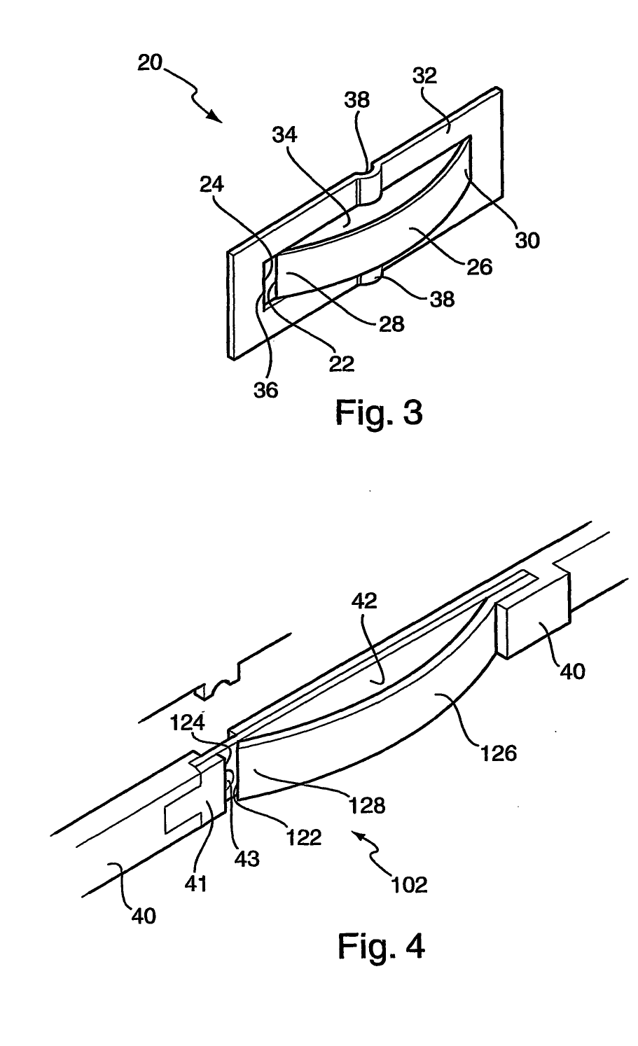

FIG. 3 shows an embodiment of cutting apparatus 20 suitable for use in a needle cutting device 101. The cutting apparatus 20 comprises a flat frame 32 with a central rectangular hole 34 created by the formation of an elongate flexible blade member 26. The blade member 26 is bowed out of the plane of the frame such that only the end 30 attached to the frame 32 and the free end 28 remain in the plane of the frame 32. The free end 28 of the blade member 26 has a cutting surface 22. An edge 36 of the hole 34 opposed to the cutting surface 22 forms the second cutting surface 24 of the cutting apparatus 20.

The cutting apparatus 20 is suitable for use in the cutting device 101 because the cutting surfaces 22,24 are located off-centre.

The frame 32 has folds 38 in sides 40 to shorten the length of the frame 32 in a direction parallel to the elongate blade member 26. This is so that the cutting surfaces may be brought together to nip and cut a needle 6 passing between them by flexing the elongate blade member to move it substantially into the plane of the frame 32.

To create the cutting apparatus 20 a flat rectangular workpiece of metal is stamped such that three cuts are formed through the metal to define the size of the hole 34 and elongate blade member 26. The workpiece is then formed to create the bow in the blade member 26 and the folds 38 in the frame 32. The cutting surfaces 22,24 may then be sharpened.

FIG. 4 shows a different embodiment of the cutting apparatus in FIG. 3. The principle of operation is the same, but the construction is no longer one piece. Features of this embodiment that are the same as in FIG. 3 are given similar reference numeral incremented by 100.

The cutting apparatus 120 has a different construction to the cutting apparatus 20. Cutting apparatus 120 is supported in a housing 40. The blade member 126 is bowed, and is arranged such that the first cutting surface 122 may be brought together with the second cutting surface 124 which is formed on a separate workpiece 41.

A back plate 42 is also supported by the housing 40 and is located behind the blade member and workpiece 41. The back plate 42 provides support and prevents misalignment of the cutting surfaces during a nip and cut operation. The back plate 42 has an aperture 43 through which only the needle 6 of the syringe 8 may pass.

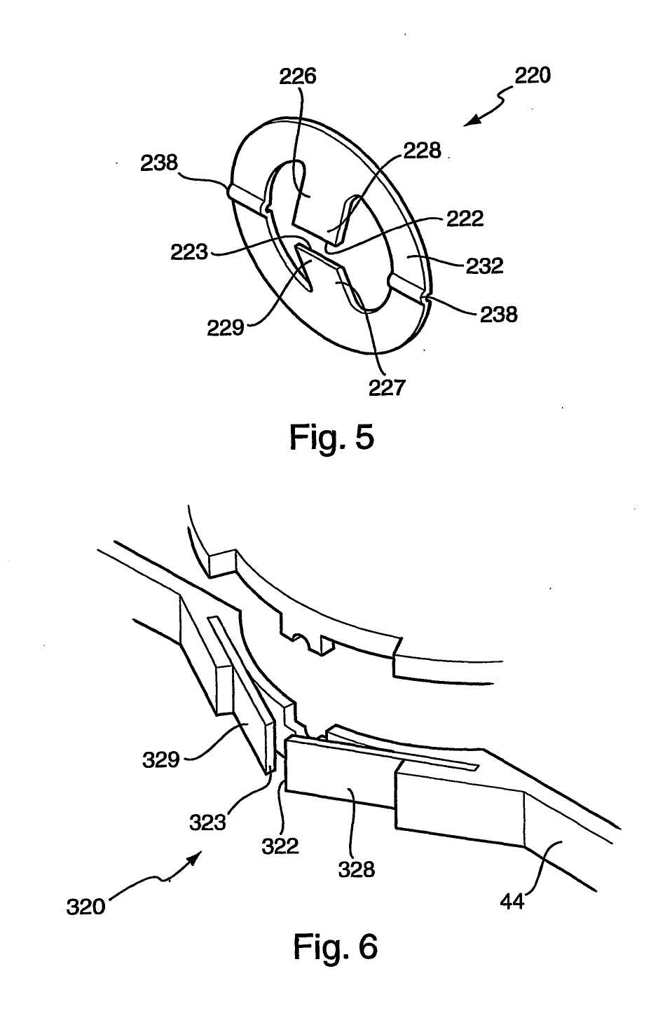

FIG. 5 shows a different embodiment of a cutting apparatus suitable for use in needle cutting device 1.

Features that are similar to the embodiment 20 of FIG. 3 will be referenced with similar numerals incremented by 200.

The cutting apparatus 220 is of a unitary structure and comprises a flat frame 232 and two opposing flexible blade members 226,227. The blade members 226,227 project at an angle from the plane of the frame 232 so that cutting surfaces 222,223 at the ends 228,229 of the blade members are not in the same plane as the frame 232.

Since the blade members 226,227 are formed from the same workpiece as the frame 232, the frame 232 includes folds 238 that bring the cutting surfaces 222,223 closer together to enable a nip and cut operation to be performed to cut a needle that is between the cutting surfaces 222,223. The cutting apparatus 220 is suitable for use with the cutting device 1 because the cutting surfaces 222,223 are located centrally.

The cutting apparatus 220 is formed in a similar way to the cutting apparatus 20 of FIG. 1. The flat workpiece is cut in an ‘H’ formation to form the blade members 226,227. The workpiece is then formed to raise the ends 228,229 of the blade members 226,227 out of the plane of the frame 232 and form the folds 238 in the frame 232.

FIG. 6 shows a different embodiment of the cutting apparatus of FIG. 3. Features that are the same as those in FIG. 3 will be referenced with similar reference numerals incremented by 300.

The cutting apparatus 320 works in a similar manner to the cutting apparatus 220 of FIG. 4. The blade members 328,329 are no longer part of a unitary structure, but are supported in a housing 44. The housing 44 allows the blade members 328,329 to flex and hence cause the cutting surfaces 322,323 to come together to nip and cut a needle 6 passing between them.

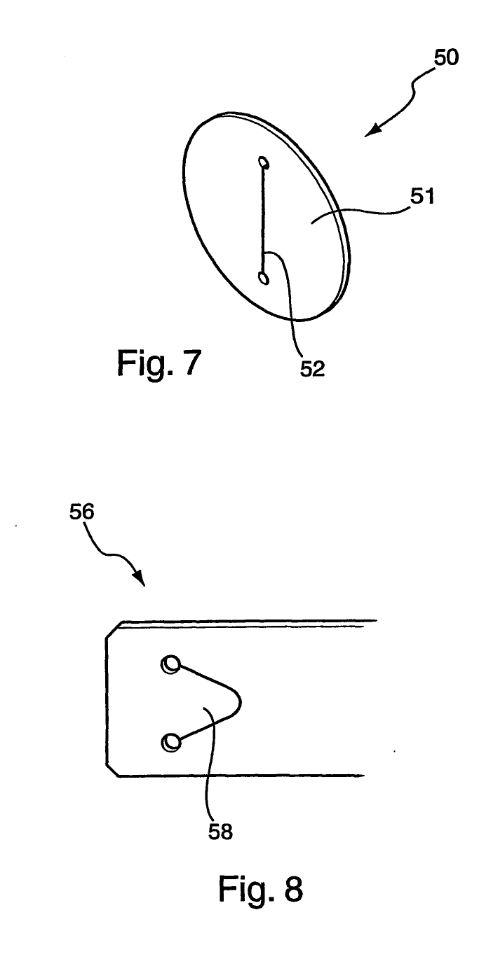

FIG. 7 shows a non-return valve 50 for use in a needle cutting device 1. The non-return valve 50 is made from a disc 51 of flat flexible material such as rubber and has a slit 52. The non-return valve is placed adjacent to the aperture 4 for entry into the container 2. The needle 6 may be forced through the slit 52, but is not able to exit the container 2.

FIG. 8 shows a different embodiment of a non-return valve 56 for use in cutting device 101. In this embodiment, the valve 56 takes the form of a resiliently closed flap 58 that may be forced open by the action of a needle 6 entering the container 102. Once the needle 6 has been cut off and the cut portion has entered the container 102, the flap shuts and prevents the needle from exiting the container 102 once it has been cut.

It should be understood that the non-return valves 50,56 are suitable for use in either of the cutting devices 1,101, although their shape may need to be adapted.

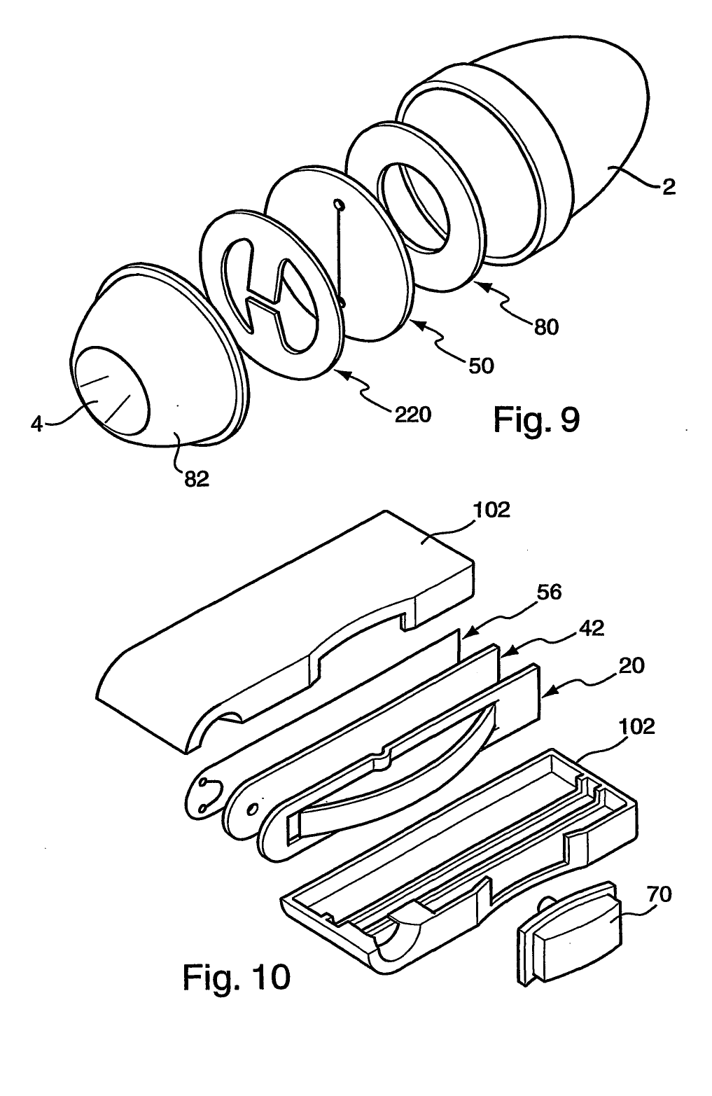

FIG. 9 shows an exploded diagram of cutting device 1. The device 1 includes a cap 82 including the aperture 4. Behind the cap 82 there is cutting apparatus 220, a non-return valve 50 and a support annulus 80 before the container 2 is reached. The cap 82 and container 2 form the outer surface of the device 1 when assembled and house the other parts 220,50,80.

FIG. 10 shows an exploded diagram of cutting device 101.

In this device the container 102 is in two halves. The cutting apparatus 20, the back plate 42 and non-return valve 26 are housed within the container 102. The device includes a button 70 for actuating the cutting apparatus 20.

FIG. 11 shows a cross section through a needle cutting device 101 in use with a syringe 8. The needle 6 of the syringe 8 has been forced through the aperture 4 along the axis 105 and into the container 102. The needle cutting device 101 has cutting apparatus that works in a similar manner to the cutting apparatus 20,120 shown in FIGS. 3 and 4.

The mount 10 of the syringe is forced as far into the aperture as possible and the button 70 is pressed. The action of pressing the button 70 causes a force on part of the blade member 26 in a direction substantially parallel to the axis 105 of the aperture 104 and the force causes part of the blade member to move with a component of that movement in a direction substantially parallel to the axis of the aperture. This causes the first cutting surface 22 to move along a back plate 72 in a direction transverse to the axis 105 of the aperture 104. This movement first traps the needle between the first and second cutting surfaces 22,24 and then causes the cutting surfaces 22,24 to nip and cut the needle 6 at or adjacent the mount 10.

Once the needle 6 has been cut from the mount 10, the flap 58 of the non-return valve springs closed and the cut needle is trapped within the container 102.

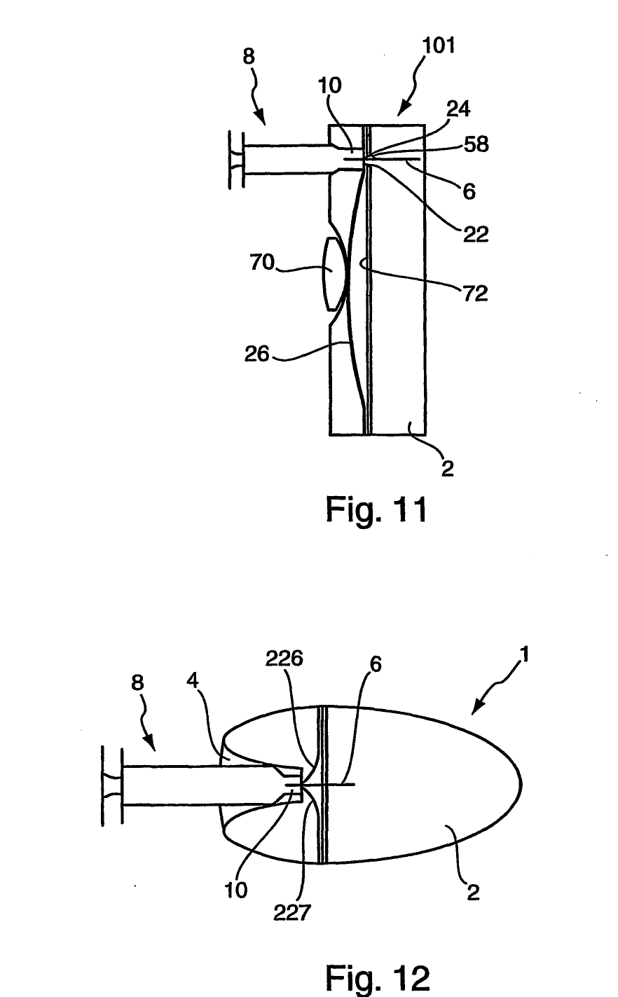

FIG. 12 shows a cross section of a different needle cutting device 1 with a needle 6 from a syringe inserted into the aperture 4 along the axis 5. The device 1 includes cutting apparatus that operates in a manner similar to the cutting apparatus 220,320 shown in FIGS. 4 and 5.

As the syringe 8 is forced into the aperture 4, the mount 10 makes contact with blade members 226,227. As the syringe 8 is forced further into the aperture 4, the needle moves further into the container 2 and cutting surfaces 222,223 on the blade members 226,227 are forced towards each other by the movement of the mount. When the mount is moved sufficiently far into the aperture 4, the cutting surfaces 222,223 will come together to nip and cut the needle 6 from the mount 10. The action of the mount on the cutting surfaces 222,223 may cause the cutting surfaces to cut a portion of the mount 10 from the syringe along with the needle 6. This will leave a recess in the mount and will help to ensure that a needle stick injury from the syringe is less likely. The cut needle 6 will then be retained within the container 2.

It should be understood that some features have, for convenience been shown as relating to only one embodiment, and that these features may be combined with one or more features shown as relating to on or more other embodiments.

The disclosures of British patent application No. 0115191.9 from which this application claims priority, and of the abstract accompanying this application are incorporated herein by reference.

1. A needle cutting device for cutting a needle from a mount in a syringe, the device comprising a container for storing cut needles, the container including an aperture having an axis along which a needle, but not a mount associated with said needle, may be introduced into the container, the device including cutting apparatus comprising first and second cutting surfaces, at least the first cutting surface being located at an end of a flexible blade member, the first cutting surface being movable relative to the second cutting surface in a direction transverse to the axis of the aperture by a force applied to at least part of the flexible blade member in a direction substantially parallel to the axis of the aperture in order to nip and cut a needle within the aperture.

2. A needle cutting device as claimed in claim 1, in which the first cutting surface is movable relative to the second cutting surface in a direction transverse to the axis of the aperture to nip and cut a needle within the aperture at or adjacent the mount such that substantially no portion of the remaining needle protrudes from the mount.

3. A device as claimed in claim 1 or claim 2, in which biasing means resiliently bias the first and second cutting surfaces to a predetermined position.

4. A device as claimed in claim 3, in which the predetermined position for the first and second cutting surfaces is such that the aperture is substantially covered such that a cut needle may not exit the container.

5. A device as claimed in claim 1, wherein the arrangement is such that movement of a syringe to a predetermined location in which the needle is disposed through the aperture causes or permits the cutting surfaces to cut the needle from its mount so as to leave substantially no portion of the needle projecting from the mount.

6. A device as claimed in claim 3, wherein the resilient biasing means is a leaf spring.

7. A device as claimed in claim 6, in which the blade member forms said leaf spring.

8. A device as claimed in claim 7, in which the blade member and first and second cutting surfaces are parts of a unitary structure.

9. A device as claimed in claim 1, in which the aperture includes a non-return valve.

10. A device as claimed in claim 1, in which the movement of the at least part of the blade member is caused by contact with the mount during the insertion of a needle into the aperture.

11. A needle cutting device for cutting a needle from a mount in a syringe, the device comprising a container for storing cut needles, the container including an aperture having an axis along which a needle, but not a mount associated with said needle, may be introduced into the container, the device including cutting apparatus comprising first and second cutting surfaces, at least the first cutting surface being located at an end of a flexible blade member, the first cutting surface being movable relative to the second cutting surface in a direction transverse to the axis of the aperture to nip and cut a needle within the aperture at or adjacent the mount such that substantially no portion of the remaining needle protrudes from the mount.

12. A needle cutting device for removing a needle from a mount in a syringe, the device comprising a container for storing cut needles, the container including an aperture through which a needle, may be introduced into the container, the device including cutting apparatus;
the arrangement being such that movement of the syringe to a predetermined location in which the needle is disposed through the aperture causes or permits the cutting apparatus to cut the needle from its mount so as to leave substantially no portion of the needle projecting from the mount.
